(19) United States
(12) Patent Application Publication
(10) Pub. No.: US 2025/0362837 A1
(43) Pub. Date: Nov. 27, 2025

(54) ELECTRONIC TERMINAL DEVICE CAPABLE OF DISPLAYING THUMBNAIL SCREEN SHOWING THUMBNAIL IMAGE OF EACH PAGE IN PRINT DATA AND SETTING ITEM SCREEN SHOWING SETTING ITEMS FOR EXCEPTIONAL SETTING, AND NON-TRANSITORY COMPUTER-READABLE RECORDING MEDIUM WITH PRINT SETTING PROGRAM STORED THEREON

(71) Applicant: KYOCERA Document Solutions Inc., Osaka (JP)

(72) Inventors: Shunsuke SASAKI, Osaka (JP); Takanori MIYAMOTO, Osaka (JP)

(73) Assignee: KYOCERA Document Solutions Inc., Osaka (JP)

(21) Appl. No.: 19/213,782

(22) Filed: May 20, 2025

(30) Foreign Application Priority Data
May 23, 2024 (JP) 2024-084413

(51) Int. Cl. G06F 3/12

(52) U.S. Cl. CPC G06F 3/1205; G06F 3/1219; G06F 3/1241; G06F 3/1256; G06F 3/1286

(57) ABSTRACT

The controller creates setting for a job of printing to which general setting and exceptional setting are applied. The display controller allows the display device to concurrently display a thumbnail screen showing a list of thumbnail images of pages in print data and a setting item screen showing a setting item for the exceptional setting and display the thumbnail image as a choice indicated by a selection instruction accepted by the input accepting device, in a display manner different from a manner to display the thumbnail image other than the choice. The controller applies, to the page represented by the thumbnail image as the choice, a content of the setting item for the exceptional setting having been accepted by the input accepting device. The display controller allows the display device to display the content of the setting item for the exceptional setting on the setting item screen.

### INCORPORATION BY REFERENCE

This application claims priority to Japanese Patent Application No. 2024-084413 filed on 23 May 2024, the entire contents of which are incorporated by reference herein.

### BACKGROUND

The present disclosure relates to electronic terminal devices capable of transmitting a print instruction to an image forming apparatus and non-transitory computer-readable recording media with print setting programs stored thereon.

In the commercial printing industry in which orders for creating print products are received from customers and printed products desired by the customers are delivered, with the development of digital printing, a method has been increasingly used that realizes a desired print by combining general setting indicating print setting for all pages contained in print data with exceptional setting indicating print setting for a specified range of pages in the print data.

For example, a first technique is generally known in which print processing conditions of a print job containing image data on images of a plurality of pages are partially changeable. For another example, a second technique is known in which, regarding a saved print job, mismatch between a print desired by the user and a print recognized by a printing system can be reduced.

A third technique is also known in which in changing print setting for print data, items for the print setting to be enabled or disabled in terms of imaging information on the print data are displayed to the user. A fourth technique is also known that enables the user to easily make a comparison between images to be printed based on different print settings.

### SUMMARY

A technique improved over the aforementioned techniques is proposed as one aspect of the present disclosure.

An electronic terminal device according to an aspect of the present disclosure is an electronic terminal device that transmits a print instruction to an image forming apparatus. The electronic terminal device includes a display device, an input accepting device, and a control device. The input accepting device accepts an input of an instruction from a user. The control device includes a processor and functions, through the processor executing a print setting program, as a controller and a display controller. The controller creates, in accordance with the instruction accepted by the input accepting device, setting for a job of printing to which general setting indicating print setting for all pages contained in print data and exceptional setting indicating print setting for a predetermined range of pages in the print data are applied. The display controller allows the display device to display a setting screen for use in setting the job. The display controller allows the display device to concurrently display, in the setting screen, a thumbnail screen showing a list of thumbnail images of the pages in the print data and a setting item screen showing a setting item for the exceptional setting and display the thumbnail image as a choice indicated by a selection instruction accepted by the input accepting device, in a display manner different from a manner to display the thumbnail image other than the choice. The controller applies, to the page represented by the thumbnail image as the choice, a content of the setting item for the exceptional setting having been accepted by the input accepting device. The display controller allows the display device to display the content of the setting item for the exceptional setting on the setting item screen.

A non-transitory computer-readable recording medium according to another aspect of the present disclosure stores a print setting program to be executed by an electronic terminal device that transmits a print instruction to an image forming apparatus. The print setting program allows the electronic terminal device including a display device, an input accepting device capable of accepting an input of an instruction from a user, and a processor to execute, through the processor executing the print setting program, the steps of: allowing the display device to display a setting screen for use in setting a job of printing; allowing the display device to concurrently display, in the setting screen, a thumbnail screen showing a list of thumbnail images of pages in print data and a setting item screen showing a setting item for exceptional setting being print setting for a predetermined range of pages in the print data; allowing the display device to display, in the thumbnail screen, the thumbnail image as a choice indicated by a selection instruction accepted by the input accepting device, in a display manner different from a manner to display the thumbnail image other than the choice; applying, to the page represented by the thumbnail image as the choice, a content of the setting item for the exceptional setting having been accepted by the input accepting device; and allowing the display device to display, among the thumbnail images displayed on the thumbnail screen, the thumbnail image of the page to which the content of the setting item for the exceptional setting is applied, together with visually discriminable information added to the thumbnail image of the page.

### BRIEF DESCRIPTION OF THE DRAWINGS

FIG. 1 is a schematic view showing a printing system.

FIG. 2 is a diagram showing an electric configuration of the printing system.

FIGS. 3 to 9 are views showing display examples of a display device of an electronic terminal device.

### DETAILED DESCRIPTION

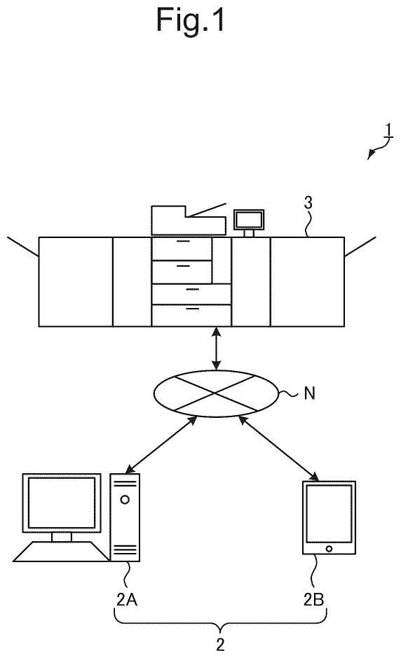

Hereinafter, a description will be given of a printing system and a print setting program according to one embodiment of the present disclosure with reference to the drawings. FIG. 1 is a schematic view of a printing system 1 according to the one embodiment of the present disclosure. The printing system 1 is constituted by an electronic terminal device 2, an image forming apparatus 3, a network N, and so on. The electronic terminal device 2 is a personal computer (PC) 2A or a mobile terminal 2B, such as a smartphone or a tablet device. The image forming apparatus 3 is an apparatus that prints print products (such as brochures, flyers or posters) for business or project activities of companies or organizations. The network N is a communication network, such as a LAN (local area network) or the Internet, capable of sending and receiving data.

When the user operates the electronic terminal device 2 to give a print instruction for the image forming apparatus 3, the electronic terminal device 2 transmits a print job based on the instruction to the image forming apparatus 3. The image forming apparatus 3 performs printing in accordance with the received print job.

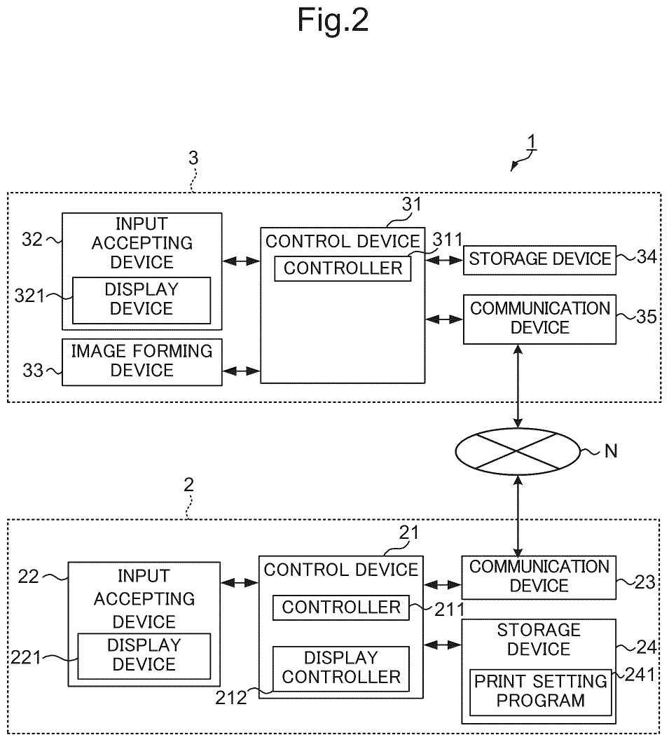

FIG. 2 is a diagram showing an electric configuration of the printing system 1. As shown in FIG. 2, the electronic terminal device 2 includes a control device 21, an input accepting device 22, a communication device 23, a storage device 24, and so on.

The input accepting device 22 is a keyboard or a pointing device, such as a mouse. The input accepting device 22 accepts various instructions from a user. A display device 221 includes an LCD (liquid crystal display) or the like. The display device 221 may be formed integrally with a touch panel (which may be an example of the input accepting device 22). In this embodiment, the display device 221 is assumed to be formed integrally with a touch panel.

The communication device 23 is a communication module that transfers various data to and from external devices, such as the image forming apparatus 3, via the network N, such as the Internet. The storage device 24 is a large-capacity storage device that is constituted by an SSD (solid state drive), an HDD (hard disk drive) or the like and stores various programs, a data table or so on. The storage device 24 stores a print setting program 241. When the control device 21 executes the print setting program 241, it serves as a controller 211 to execute print setting processing.

The control device 21 is constituted by a processor, a RAM (random access memory), a ROM (read only memory), and so on. The processor is, for example, a CPU (central processing unit), an MPU (micro processing unit) or an ASIC (application specific integrated circuit). When the processor executes the print setting program 241 stored in the storage device 24, the control device 21 functions as the controller 211 and a display controller 212. The controller 211 governs the overall operation control of the electronic terminal device 2. The display controller 212 performs display control of the display device 221.

Next, a description will be given of an electric configuration of the image forming apparatus 3. The image forming apparatus 3 includes a control device 31, an input accepting device 32, an image forming device 33, a storage device 34, a communication device 35, and so on.

The input accepting device 32 includes hard keys, including a decision key for giving a definite instruction for various operations or settings and a start key, and a display device 321. The input accepting device 32 accepts various instructions from a user. The display device 321 includes an LCD or the like. The display device 321 displays an operation screen, a message or so on. The display device 321 may be formed integrally with a touch panel. In this embodiment, the display device 321 is assumed to be formed integrally with a touch panel. The input accepting device 32 accepts an instruction input based on an operation on a hard key, such as the decision key or the start key, or a gesture on the touch panel.

The image forming device 33 includes, for example, an electrophotographic image forming mechanism or the like. The image forming device 33 prints an image on a sheet in accordance with a print job received from the electronic terminal device 2. The storage device 34 is a large-capacity storage device that stores image data, various programs, a data table, or so on. The communication device 35 is a communication module that transfers various types of data including print data to and from external devices, such as the electronic terminal device 2, via the network N, such as the Internet.

The control device 31 is constituted by a processor, a RAM, a ROM, and so on. The processor is a CPU, an MPU, an ASIC or the like. When the processor executes a control program stored in the ROM or so on, the control device 31 functions as a controller 311. The controller 311 governs the overall operation control of the image forming apparatus 3.

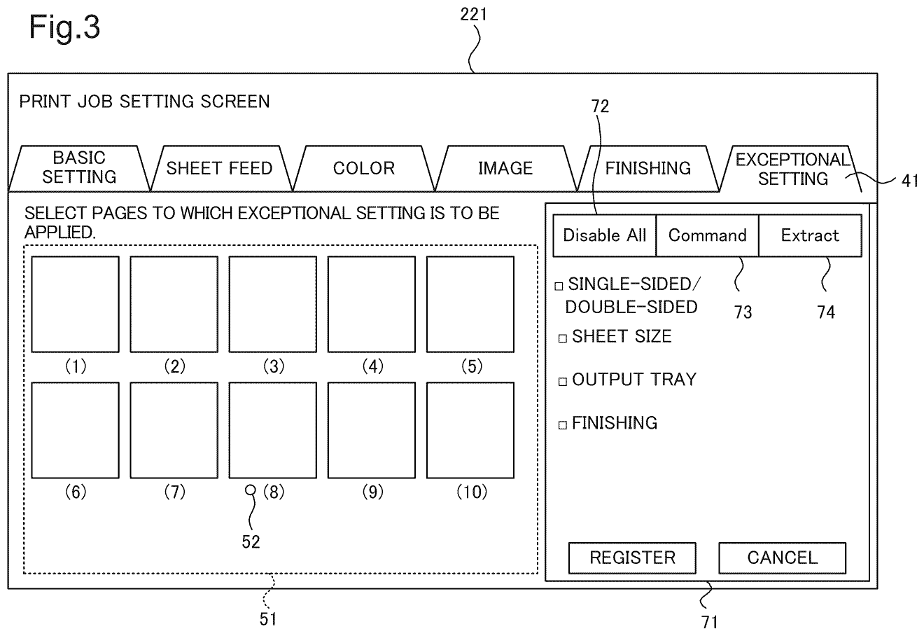

Next, a description will be given of print setting processing. FIG. 3 is a view showing an example of an exceptional setting screen displayed on the display device 221 of the electronic terminal device 2. Setting for a job of printing (hereinafter, referred to as “print setting”) includes the following two types of setting: general setting indicating setting for all pages contained in print data; and exceptional setting indicating setting for a predetermined range of pages in the print data.

When the user inputs an instruction to set a print job to the input accepting device 22 of the electronic terminal device 2, the controller 211 allows the display device 221 to display a print job setting screen.

In doing exceptional setting while the print job setting screen is displayed, the user makes a touch gesture on a tab 41. When, based on this touch gesture, an instruction to display an exceptional setting screen is input to the input accepting device 22, the display controller 212 allows the display device 221 to display an exceptional setting screen as shown in FIG. 3.

The exceptional setting screen includes a thumbnail screen 51 and a setting item screen 71. The display controller 212 allows the display device 221 to display thumbnail images of all pages contained in a print job on the thumbnail screen 51. In order that the user can recognize the presence or absence of any exceptional setting for each of the pages represented by the thumbnail images, the display controller 212 allows the display device 221 to display a thumbnail image of every page to which any exceptional setting is applied, together with visually discriminable information added to this thumbnail image. In this embodiment, the display controller 212 allows the display device 221 to display, for example, an open circle 52 as visually discriminable information just below the thumbnail image of the page to which any exceptional setting is applied. By displaying a list of thumbnail images of all the pages and also displaying, as to the thumbnail images of the pages to which any exceptional setting is applied, open circles 52 or the like affixed just below these thumbnail images as just described, the user can easily recognize to which page any exceptional setting is applied.

The display controller 212 allows the display device 221 to display various buttons and setting items for exceptional setting on the setting item screen 71. The various buttons are a disable button 72, a command button 73, and an extract button 74. The disable button 72 is a button for use in accepting an instruction to disable every exceptional setting made for the pages concerned (clear the exceptional setting). The command button 73 is a button for use in accepting an instruction to display on the thumbnail screen 51 only the thumbnail image of every page that satisfies a condition defined by a specified command. The extract button 74 is a button for use in accepting an instruction to display on the thumbnail screen 51 only the thumbnail image of every page to which a selected item of the exceptional setting is applied. Respective kinds of processing to be executed in accordance with the instructions input by operating these three buttons will hereafter be described in detail.

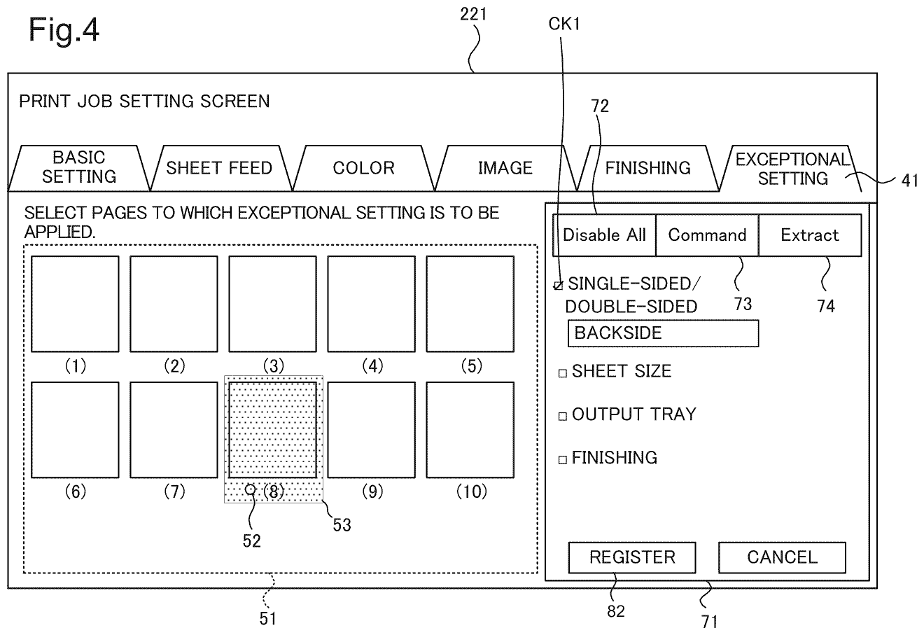

For example, when, in FIG. 3, the user touches the thumbnail image of the eighth page to which exceptional setting is applied and an instruction to select the eighth page is accepted by the input accepting device 22, the controller 211 recognizes the eighth page as being in a selected state and the display controller 212 allows the display device 221 to display a rectangular 53 superposed on the thumbnail image of the eighth page, wherein the rectangular 53 is a display manner indicating that the eighth page is in a selected state (see FIG. 4). In other words, the display controller 212 allows the display device 221 to display the thumbnail image as a choice based on a selection instruction accepted by the input accepting device 22, in a display manner (the rectangular 53) different from that of the thumbnail images other than the choice. The rectangular 53 is an image that tinges the selected thumbnail image with a rectangular image of a predetermined color (for example, blue).

Furthermore, according to the content of the exceptional setting applied to the selected eighth page, the display controller 212 allows the display device 221 to display, on the setting item screen 71, an image CK1 representing a check mark beside the item having that content set by the exceptional setting. In an example shown in FIG. 4, the content of an item “Single-sided/Double-sided” for setting the printing surface is set by the exceptional setting and an image representing a check mark is displayed beside a location where the item “Single-sided/Double-sided” is displayed. This means that, by the exceptional setting, the content of the item “Single-sided/Double-sided” for the eighth page has been changed from the content set by general setting. This example shows that, regarding the setting for the printing surface, printing of an image on the backside of a sheet is applied as exceptional setting to the eighth page.

While the display controller 212 allows the display device 221 to display the exceptional setting screen and the setting item screen 71 in the above manner, the controller 211 sets or changes the contents of setting items for exceptional setting for the selected page in accordance with an instruction input to the input accepting device 22. As shown in FIG. 4, the display controller 212 allows the display device 221 to display items settable as exceptional setting on the setting item screen 71.

When the user makes an operation for specifying an item as a subject having a content to be set and an operation for inputting a content to be set for the item on the input accepting device 22 and subsequently makes a touch gesture on a Register button 82 and, thus, an instruction to register the input content is input to the input accepting device 22, the controller 211 applies, to the selected page, the content input for the specified item as exceptional setting. In the case where any content has already been set for the item that is a subject having a content to be set, the controller 211 applies, in place of the already set content, the content newly input for the specified item as exceptional setting. The display controller 212 allows the display device 221 to display on the setting item screen 71 the content of the item for exceptional setting applied in this manner.

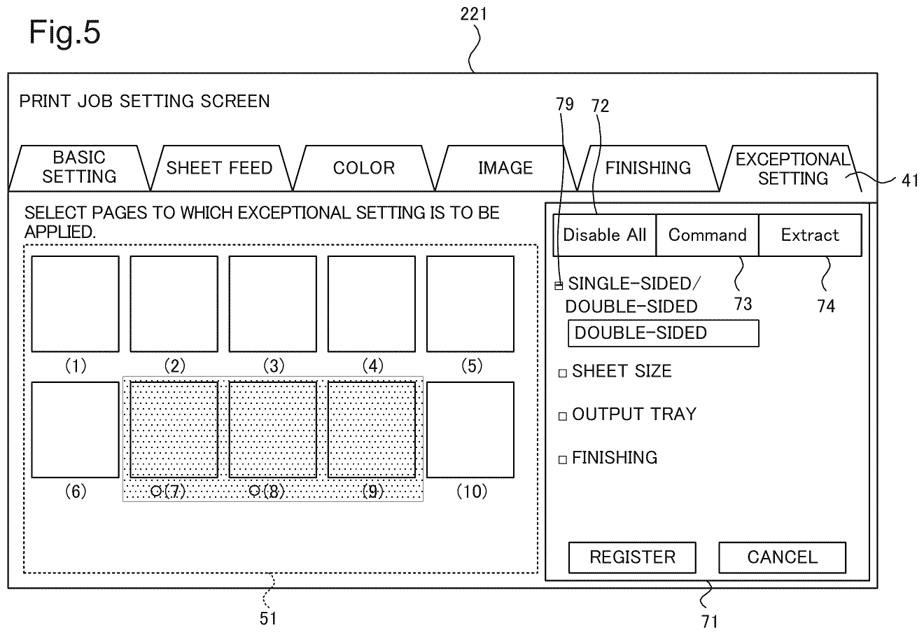

FIG. 5 is a view showing an example of the exceptional setting screen when the thumbnail images of a plurality of pages (the seventh to ninth pages) are selected. In FIG. 5, any exceptional setting is applied to the seventh page and the eighth page (open circles are displayed just below their thumbnail images), but no exceptional setting is applied to the ninth page. In other words, the seventh to ninth pages are different in the content of exceptional setting. In this case, the display controller 212 discriminates among contents of exceptional setting for the seventh to ninth pages and allows the display device 221 to display an image 79 representing a minus sign in a check box for the item in terms of which set contents are different among the selected pages. So long as the user can visually recognize that set contents are different among the selected pages, any alternative display manner to the image 79 representing a minus sign may be adopted, such as an image representing a different sign.

In the case where, as just described, thumbnail images of a plurality of pages are selected and the contents of exceptional setting applied to the pages represented by the selected thumbnail images are different among the pages, the image 79 representing a minus sign or the like is displayed in, among the check boxes for the setting items displayed on the setting item screen 71, the check box for the setting item in terms of which set contents are different among the pages. Therefore, the user can immediately know that the contents of exceptional setting applied to these pages are different among these pages.

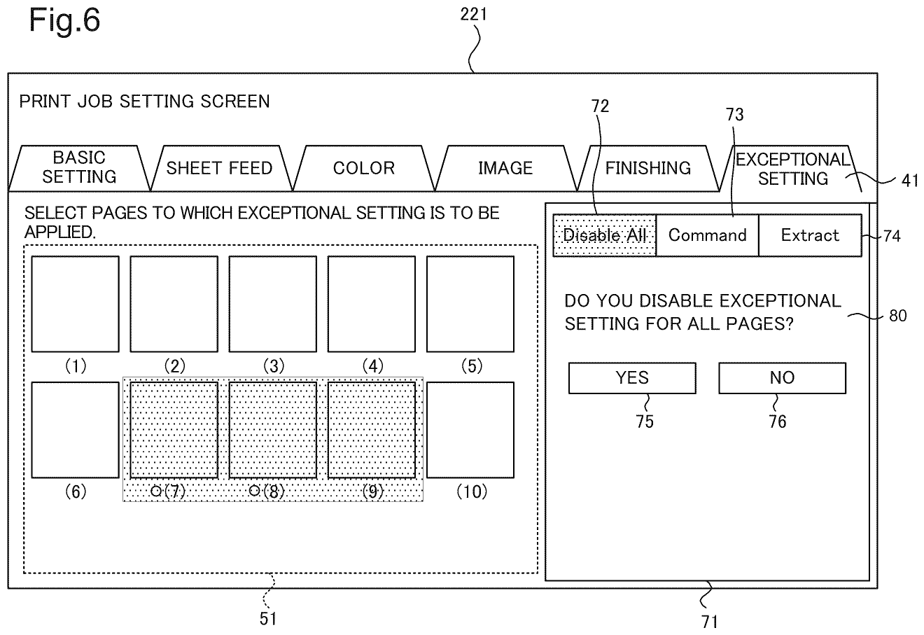

When the input accepting device 22 accepts a disabling instruction based on a touch gesture on the disable button 72 while the exceptional setting screen shown in FIG. 3 is displayed, the display controller 212 allows the display device 221 to display, on the setting item screen 71, a message 80 prompting to confirm whether or not to disable every exceptional setting made for the pages concerned, as shown as an example in FIG. 6.

When the user operates a button 75 and, thus, an instruction to execute disabling processing is accepted by the input accepting device 22, the controller 211 executes the disabling processing for disabling every exceptional setting for all the pages. On the other hand, when an instruction not to execute disabling processing is accepted by the input accepting device 22 based on a user's operation on a button 76, the controller 211 does not execute the disabling processing and the display controller 212 allows the display device 221 to display an initial exceptional setting screen shown in FIG. 3. The user can easily cancel every exceptional setting by the disabling processing.

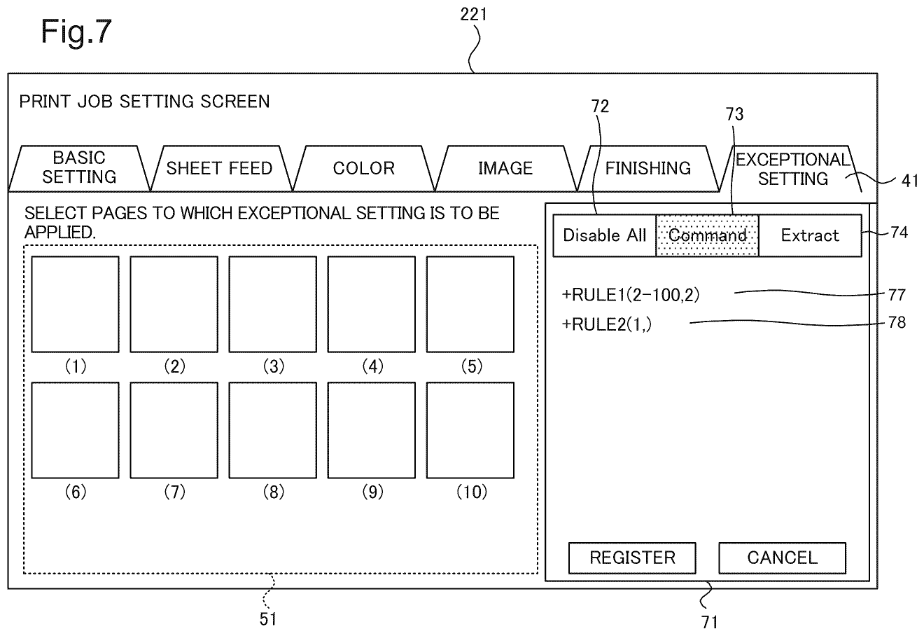

When the input accepting device 22 accepts a search instruction based on a touch gesture on the command button 73 while the exceptional setting screen shown in FIG. 3 is displayed, the display controller 212 allows the display device 221 to display a list of commands on the setting item screen 71, as shown as an example in FIG. 7. Specifically, the command button 73 is a button for use in accepting a search instruction for the purpose of displaying on the thumbnail screen 51 only the thumbnail image of every page that satisfies a condition defined by a command.

Commands appearing in the command list shown in FIG. 7 are merely illustrative. Among these commands, a command 77 is a command that requests to select the last one of every two pages (every second page) in a range from the 2nd page to the 100th page. A command 78 is a command that requests to select the first page only. The input accepting device 22 accepts an input of a command based on a user's operation. The display controller 212 allows the display device 221 to display in the command list the command the input of which has been accepted.

It is also possible that the storage device 24 previously stores a plurality of types of commands, the controller 211 allows the storage device 24 to store a command input by a user's operation on the input accepting device 22, the controller 211 reads, in accordance with a user's instruction input to the input accepting device 22, the command indicated by the instruction from the storage device 24, and the display controller 212 allows the display device 221 to display the read command in the command list on the setting item screen 71 as shown as an example in FIG. 7.

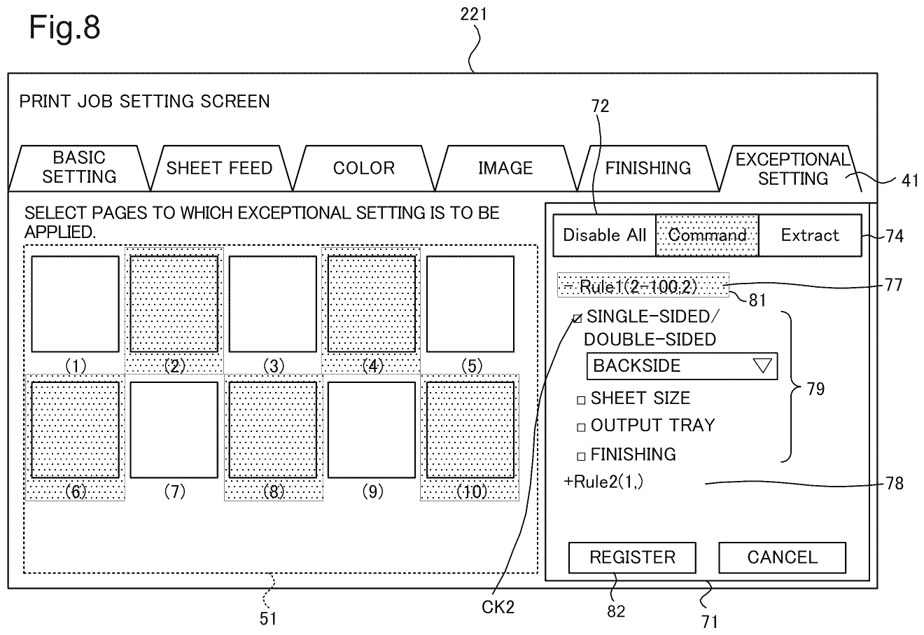

When, in the example shown in FIG. 7, the input accepting device 22 accepts an instruction to select a command based on a user's touch gesture on the command 77 appearing in the command list, the display controller 212 allows the display device 221 to display, as shown as an example in FIG. 8, the command 77 in a display manner to show that the command 77 is selected, i.e., with a rectangle 81 superposed on the command 77 in this case. The rectangular 81 is an image that tinges the selected command with a rectangular image of a predetermined color (for example, blue). According to the content indicated by the selected command 77, the controller 211 extracts every page number that satisfies the command 77 and the display controller 212 allows the display device 221 to display the thumbnail image(s) having the extracted page number(s) in a selected state, i.e., in the above-described display manner when the thumbnail image is selected. FIG. 8 shows a display example where the second, fourth, sixth, eighth, and tenth pages are selected.

Furthermore, the display controller 212 allows the display device 221 to display items settable as exceptional setting, as shown by an image 79. When the user makes an operation for specifying an item as a subject having a content to be set and an operation for inputting a content to be set for the item on the input accepting device 22 and subsequently makes a touch gesture on the Register button 82 and, thus, an instruction to register the input content is input to the input accepting device 22, the controller 211 applies, to the selected pages, the content input for the specified item as exceptional setting.

For example, when backside printing is applied to the selected second, fourth, sixth, eighth, and tenth pages, the display controller 212 allows the display device 221 to display a check mark CK2 and an image representing that backside printing is set, beside a location where the item “Single-sided/Double-sided” for setting the printing surface is displayed on the setting item screen 71 in the exceptional setting screen, as shown as an example in FIG. 8. As thus far described, in the case where a print job contains a large number of pages to be printed, a command is used to collectively specify a plurality of pages as pages to which exceptional setting is to be applied. Thus, a plurality of pages to which exceptional setting is to be applied can be easily extracted and the content of exceptional setting can be set for these plurality of pages collectively.

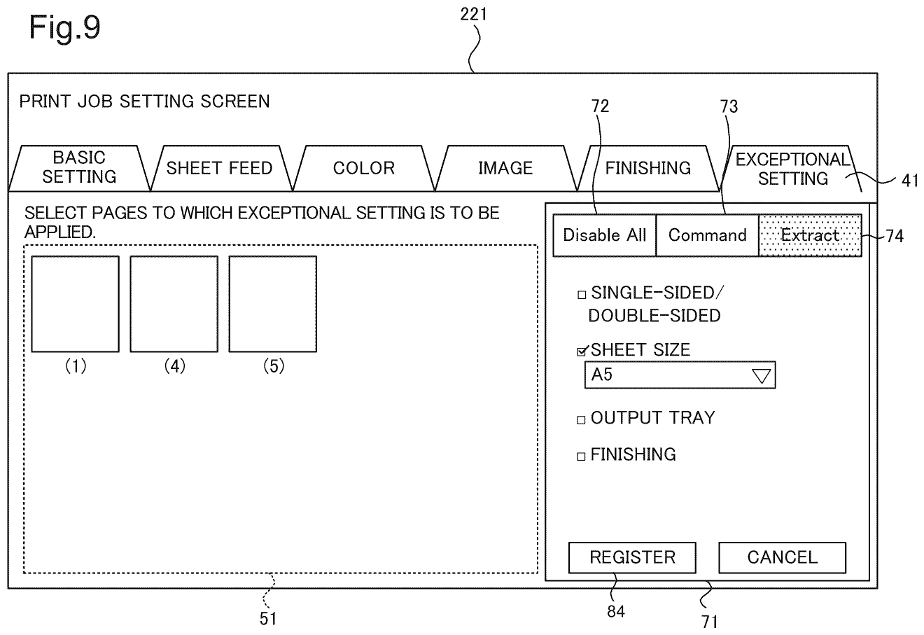

The extract button 74 displayed on the setting item screen 71 in the exceptional setting screen is a button for use in instructing to display on the thumbnail screen 51 only the thumbnail image of every page to which a specified item for exceptional setting is applied. When an instruction to display the items for exceptional setting is input to the input accepting device 22 based on a user's touch gesture on the extract button 74, the display controller 212 allows the display device 221 to display an image representing items for exceptional setting on the setting item screen 71 as shown as an example in FIG. 9. When the user makes an operation for specifying an item as a subject in terms of which every appropriate page is to be extracted and an operation for specifying a content of the item on the input accepting device 22 and subsequently makes a touch gesture on the Register button 82 and, thus, an instruction to extract every appropriate page is input to the input accepting device 22, the controller 211 sets, as pages to be extracted, the pages to which the specified set content of the specified item is applied.

FIG. 9 shows as an example the case where “Sheet Size” and “A5” are specified as a setting item and a set content, respectively. The controller 211 extracts pages to which a sheet size of A5 is applied as exceptional setting and the display controller 212 allows the display device 221 to display the thumbnail images (the first, fourth, and fifth pages in the case shown in FIG. 9) representing the extracted pages on the thumbnail screen 51. Thus, the user can immediately know, from among a plurality of pages, pages to which the specified set content of the specified item is applied as exceptional setting.

In taking a procedure for exceptional setting on a user interface (UI) provided from a system for industrial printing, it is necessary to input both the numbers of first and last pages to which exceptional setting is to be applied, which presents a problem of difficulty in inputting them without the knowledge of the page numbers and the understanding of the contents of images of the pages corresponding the page numbers. In addition, there is a problem of difficulty in promptly determining, on the UI, for which page in print data exceptional setting has been made and about what the exceptional setting is. The general first to fourth techniques described previously does not consider any solution to these problems.

Unlike these techniques, in the above embodiment, the display controller 212 allows the display device 221 to display a list of thumbnail images of pages and display, as to the thumbnail images of pages to which any exceptional setting is applied, these thumbnail images together with open circles 52 or the like added thereto. Thus, the user can easily recognize the presence or absence of exceptional setting for each page while viewing the images of the pages.

Furthermore, in the case where thumbnail images of a plurality of pages are selected on the thumbnail screen 51 and the contents of exceptional setting applied to the pages represented by the selected thumbnail images are different among the pages, the image 79 representing a minus sign or the like is displayed in, among the check boxes for the setting items displayed on the setting item screen 71, the check box for the setting item in terms of which set contents are different among the pages. Therefore, the user can immediately know that the contents of exceptional setting applied to the pages are different among the pages.

When the disable button 72 is selected, the controller 211 disables every exceptional setting applied to all the pages. Thus, the user can easily cancel every exceptional setting.

In the case where a print job contains a large number of pages to be printed, the user can use a command to specify pages and, thus, can easily extract desired pages. When further selecting the extract button 74 and specifying an item for exceptional setting, the user can immediately know every page to which exceptional setting about the specified item is applied.

As thus far described, in the above embodiment, in creating setting for a job of printing, the contents of exceptional setting can be set in a visually easily perceptible manner.

The present disclosure is not limited to the above embodiment and can be modified in various ways. The structures, configurations, and processing of the above embodiment described with reference to FIGS. 1 to 9 are merely illustrative of the present disclosure and are not intended to limit the present disclosure to them.

A non-transitory computer-readable recording medium with the print setting program according to this embodiment stored thereon is, for example, a hard disk, a CD-ROM, a DVD-ROM or a semiconductor memory.

While the present disclosure has been described in detail with reference to the embodiments thereof, it would be apparent to those skilled in the art the various changes and modifications may be made therein within the scope defined by the appended claims.

What is claimed is:

1. An electronic terminal device that transmits a print instruction to an image forming apparatus, the electronic terminal device comprising:
a display device;
an input accepting device that accepts an input of an instruction from a user;
a control device that includes a processor and functions, through the processor executing a print setting program, as:
a controller that creates, in accordance with the instruction accepted by the input accepting device, setting for a job of printing to which general setting indicating print setting for all pages contained in print data and exceptional setting indicating print setting for a specified range of pages in the print data are applied; and
a display controller that allows the display device to display a setting screen for use in setting the job,
wherein the display controller allows the display device to concurrently display, in the setting screen, a thumbnail screen showing a list of thumbnail images of the pages in the print data and a setting item screen showing a setting item for the exceptional setting and display the thumbnail image as a choice indicated by a selection instruction accepted by the input accepting device, in a different display manner from a manner to display the thumbnail image other than the choice,
the controller applies, to the page represented by the thumbnail image as the choice, a content of the setting item for the exceptional setting having been accepted by the input accepting device, and
the display controller allows the display device to display the content of the setting item for the exceptional setting on the setting item screen.

2. The electronic terminal device according to claim 1, wherein the display controller allows the display device to display, among the thumbnail images displayed on the thumbnail screen, the thumbnail image of the page to which the content of the setting item for the exceptional setting is applied, together with visually discriminable first information added to the thumbnail image.

3. The electronic terminal device according to claim 1, wherein when a plurality of the thumbnail images are displayed in the different display manner and the contents of the print setting applied to the pages represented by the plurality of thumbnail images are different among the pages, the display controller allows the display device to display, among the setting items for the exceptional setting displayed on the setting item screen, the setting item in terms of which the contents of the print setting are different among the pages, together with visually discriminable second information added to the setting item.

4. The electronic terminal device according to claim 1, wherein
the display controller allows the display device to display a disable button for use in accepting a disabling instruction to disable all the contents set as the exceptional setting, and
when the input accepting device accepts the disabling instruction based on an operation on the disable button, the controller disables all the exceptional setting applied to the pages contained in the print data.

5. The electronic terminal device according to claim 1, wherein
the display controller allows the display device to display a command button defining a predetermined condition, and
when the input accepting device accepts an operation made on the command button, the controller extracts, from all the pages contained in the print data, every page that satisfies the condition defined by the command button and the display controller allows the display device to display the thumbnail image of the page extracted by the controller, in the different display manner on the thumbnail screen.

6. The electronic terminal device according to claim 1, wherein
the display controller allows the display device to display a page extract button, and
when the input accepting device accepts a selection instruction to select at least one of the contents of the items for the exceptional setting shown on the setting item screen and accepts an operation made on the page extract button, the controller extracts, from all the pages contained in the print data, every page to which the selected content of the item for the exceptional setting is applied and the display controller allows the display device to display the thumbnail image of the page extracted by the controller, in the different display manner on the thumbnail screen.

7. The electronic terminal device according to claim 1, wherein the display controller allows the display device to display the thumbnail image as the choice in the different display manner by superposing a rectangular image of a predetermined color on the thumbnail image.

8. A non-transitory computer-readable recording medium on which a print setting program to be executed by an electronic terminal device that transmits a print instruction to an image forming apparatus is stored,
the print setting program allowing the electronic terminal device comprising a display device, an input accepting device capable of accepting an input of an instruction from a user, and a processor to execute, through the processor executing the print setting program, the steps of:
allowing the display device to display a setting screen for use in setting a job of printing;
allowing the display device to concurrently display, in the setting screen, a thumbnail screen showing a list of thumbnail images of pages in print data and a setting item screen showing a setting item for exceptional setting being print setting for a predetermined range of pages in the print data;
allowing the display device to display, in the thumbnail screen, the thumbnail image as a choice indicated by a selection instruction accepted by the input accepting device, in a display manner different from a manner to display the thumbnail image other than the choice;
applying, to the page represented by the thumbnail image as the choice, a content of the setting item for the exceptional setting having been accepted by the input accepting device; and
allowing the display device to display, among the thumbnail images displayed on the thumbnail screen, the thumbnail image of the page to which the content of the setting item for the exceptional setting is applied, together with visually discriminable information added to the thumbnail image of the page.
